(19) United States
(12) Patent Application Publication
(10) Pub. No.: US 2023/0205460 A1
(43) Pub. Date: Jun. 29, 2023

(54) STORAGE SYSTEM AND METHOD

(71) Applicant: Kioxia Corporation, Tokyo (JP)

(72) Inventors: Takeshi ISHIHARA, Yokohama Kanagawa (JP); Hidekazu TADOKORO, Kawasaki Kanagawa (JP); Yohei HASEGAWA, Fuchu Tokyo (JP)

(21) Appl. No.: 17/903,724

(22) Filed: Sep. 6, 2022

(30) Foreign Application Priority Data
Dec. 24, 2021 (JP) 2021-210918

(51) Int. Cl. G06F 3/06; G06F 12/02

(52) U.S. Cl. CPC G06F 3/0659; G06F 3/064; G06F 3/0607; G06F 12/0253; G06F 3/0679

(57) ABSTRACT

According to one embodiment, a storage system includes a host computer and a storage device. The host computer includes a file system which has a structure for managing a file by using a management structure and metadata that manage correspondence between stored data and the storage position of the data on the file system, and bitmap information for identifying a unit area that holds valid data and other unit areas. The host computer manages the management structure and the metadata, and manages the bitmap information. The storage device manages information for identifying a unit area that holds valid data in the storage device and other areas by using the bitmap information used for management of the file system shared with the host computer.

### CROSS-REFERENCE TO RELATED APPLICATIONS

This application is based upon and claims the benefit of priority from Japanese Patent Application No. 2021-210918, filed Dec. 24, 2021, the entire contents of which are incorporated herein by reference.

### FIELD

Embodiments described herein relate generally to a storage system and a method.

### BACKGROUND

A computer uses an information storage device such as a solid state drive (SSD) as an external storage device, but usually, firmware or an operating system of the information storage device performs abstraction so that the information storage device can be used without being conscious of its configuration. In addition, a concept of a file is introduced as a unit in which a user of a computer handles information, and a file system that manages a file stored in an information storage device is installed in an operating system. With these functions, use of the information storage device via a unified abstract interface is realized, but there are problems such as inefficiency due to duplication of similar functions, and difficulty in realizing optimization according to a user's usage.

For example, in the nameless write, there is disclosed a writing method in which, when writing is performed on an SSD, a host computer does not notify the SSD of a write destination address, and after the SSD determines a write destination address and stores data in a write destination area which corresponding to the write destination address, the host computer is notified of the write destination address together when the wring on the SSD is successfully completed.

In addition, NVM Express™ (NVMe™) zoned namespaces command set specification and zonefs disclose a command set designed to divide a storage device into areas each having a continuous logical block address called a zone and permit appending the data after existing data. In addition, the zonefs implements a file system when an SSD conforming to the command set is used on Linux™.

However, it is necessary to manage write destination address in each of the file system of the host computer and the SSD in the nameless write and the NVMe zoned namespaces command set specification. Therefore, the problem of duplicate implementation of similar functions has not been solved. Although the zonefs is a file system on a premise of storage of the NVMe zoned namespace command set specification, a restriction provided for the efficiency of the storage is directly transferred to the user of the file system, and the user is forced to change software.

### BRIEF DESCRIPTION OF THE DRAWINGS

FIG. 1 is a diagram illustrating a configuration of a host computer, an information storage device, and an information storage system according to a first embodiment.

FIG. 2 is a diagram for explaining data storage processing according to the first embodiment.

FIG. 3 is a diagram schematically illustrating a structure of a file system according to the first embodiment.

FIG. 4 is a flowchart of management structure CoW update in step S206 of FIG. 2.

FIG. 5 is a schematic diagram of a management structure used when a file system unit according to the first embodiment manages an unused area.

FIG. 6 is a diagram illustrating an example of an implementation of conversion from a logical address to a physical address and an example of an implementation of management of a bitmap according to the first embodiment.

FIG. 7 is a diagram illustrating an example of an operation flow of a selection unit according to the first embodiment.

FIG. 8 is a diagram illustrating a configuration of a host computer, an information storage device, and an information storage system according to a second embodiment.

FIG. 9 is a diagram illustrating a configuration of a host computer, an information storage device, and an information storage system according to a third embodiment.

FIG. 10 is a diagram illustrating a configuration of a host computer, an information storage device, and an information storage system according to a fourth embodiment.

FIG. 11 is a diagram illustrating an example of an operation flow of an information storage system according to the fourth embodiment.

FIG. 12A is a sequence diagram (part 1) illustrating FIG. 11 divided into respective elements.

FIG. 12B is a sequence diagram (part 2) illustrating FIG. 11 divided into respective elements.

FIG. 13 is a diagram illustrating a configuration of a host computer, an information storage device, and an information storage system according to a fifth embodiment.

FIG. 14A is a sequence diagram (part 1) of write processing in the fifth embodiment.

FIG. 14B is a sequence diagram (part 2) of write processing in the fifth embodiment.

FIG. 15 is a sequence diagram of write processing in a sixth embodiment.

FIG. 16 is a sequence diagram of write processing in a seventh embodiment.

### DETAILED DESCRIPTION

Embodiments will be described hereinafter with reference to the accompanying drawings.

In general, according to one embodiment, a storage system includes a host computer and a storage device. The storage device is a host management type storage device in which a stored location of data to be stored is managed by processing operated in the host computer. The host computer includes a processor, a file system and a storage control unit. The processor controls an operation of the host computer. The file system provides a function of storing data as a file on the storage device. The storage control unit controls the storage device by issuing a command to the storage device and receiving a response from the storage device. The file system has a structure for managing a file by using a management structure and metadata that manage correspondence between stored data and the storage position of the data on the file system, and bitmap information for identifying a unit area that holds valid data in the file system and a unit area that does not hold valid data. The management structure and the metadata are managed by an integrated mapping management function executed by the processor. The bitmap information is managed by an integrated unused block management function executed by the processor. The storage device includes a device control unit and one or more nonvolatile storage units. The device control unit controls an operation of the storage device. The one or more nonvolatile storage units holds data for a long period of time. The device control unit manages information for identifying unit areas that hold valid data in the storage device and unit areas that do not hold valid data by using the bitmap information used for management of the file system shared with the host computer.

### First Embodiment (Basic Structure)

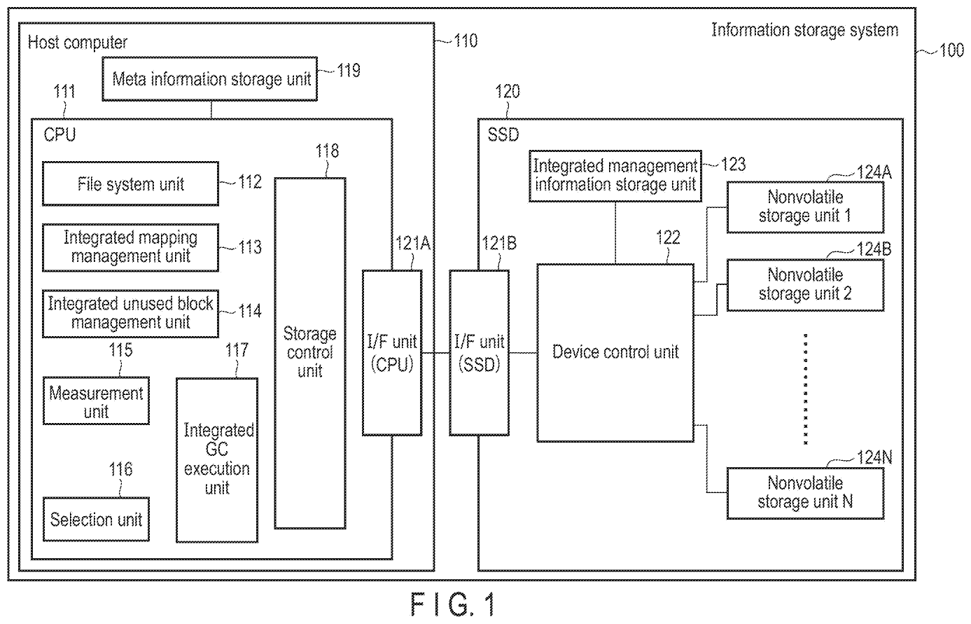

A configuration of a host computer 110, an information storage device 120 (hereinafter, an SSD 120), and an information storage system 100 according to the first embodiment is illustrated in FIG. 1.

The host computer 110 roughly includes a central processing unit (CPU) 111, a meta information storage unit 119, and an SSD 120. Other elements configuring a general computer are also included in the host computer 110, but are omitted because they do not affect an operation of the present embodiment. In addition, although the host computer 110 is described to incorporate the SSD 120, the SSD 120 may be coupled to an outside of the host computer 110 by an appropriate coupling method. Although FIG. 1 illustrates a plurality of functional blocks inside the CPU 111, the functional blocks may be realized as a dedicated circuit in the CPU 111 or may be executed as software.

The file system unit 112 is a file system that provides information stored in the SSD 120 to an application or the like (not illustrated) operating on the CPU 111 based on a concept of a file.

An integrated mapping management unit 113 realizes a function of integrating and managing a storage position in the file system and a storage position in the SSD 120 among information for maintaining and managing the file system (hereinafter, file system meta information). Specific information to be managed, a specific integration method, and a management method will be described later.

An integrated unused block management unit 114 realizes a function of integrating and managing information for managing a free area in the file system meta information and information for managing a free area in the SSD 120. Specific information to be managed, a specific integration method, and a management method will be described later.

A measurement unit 115 realizes a function of monitoring an operation of an application on an SSD through the file system unit 112, the integrated mapping management unit 113, and the integrated unused block management unit 114, and a function of providing a monitoring result to the selection unit 116. Specific operations and information of a monitoring target, a method of storing the monitored information, and the like will be described later.

The selection unit 116 realizes a function of selecting an effective garbage collection algorithm for an area used by the application based on a measurement result of the measurement unit 115. Specific examples of a selection method and a candidate garbage collection algorithm will be described later.

An integrated GC execution unit 117 realizes a function of executing valid garbage collection for both the file system and the SSD based on the selection of the selection unit 116. In the execution of the garbage collection, information of the integrated mapping management unit 113 and the integrated unused block management unit 114 is referred to, an appropriate operation is performed on the SSD 120, and the result is reflected.

A storage control unit 118 realizes a function of converting each processing executed by the CPU into a control command for the SSD 120, transmitting the control command to the SSD 120 via an I/F unit (CPU) 121A, and receiving a response to the control command from the SSD 120.

The I/F unit (CPU) 121A is an interface for coupling the SSD 120 and the CPU 111. For example, NVMe/PCIe™ can be used.

The SSD 120 roughly includes an I/F unit (SSD) 121B, a device control unit 122, an integrated management information storage unit 123, and nonvolatile storage units 1 to N (124A to 124N). Other elements are also included but are omitted here.

The I/F unit (SSD) 121B is an interface paired with the I/F unit (CPU) 121A on the CPU side.

The device control unit 122 is a part that controls the operation of the SSD 120, and is generally an element called an SSD controller. However, the SSD 120 is a host managed storage device that shares management information with the host, that is, a host managed SSD, and it is not necessary that all functions included in a general SSD controller are realized.

The integrated management information storage unit 123 is a temporary storage device that stores information necessary for managing the SSD 120. For example, the integrated management information storage unit 123 can be realized by using a DRAM. In addition, an SRAM incorporated in the device control unit 122 may be used.

The nonvolatile storage units 124A to 124N are nonvolatile storage devices that store information as the SSD 120, and for example, NAND flash memories can be used. Here, each of the N nonvolatile storage units are described to be coupled to the device control unit 122, but a coupling method between the device control unit 122 and each nonvolatile storage unit is not limited.

### Regarding Write Operation

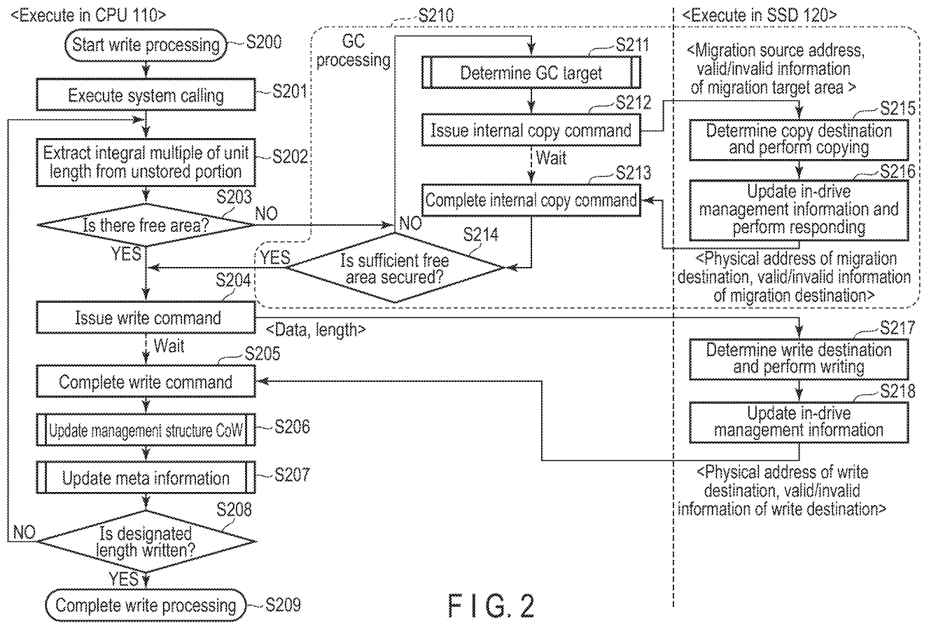

First, data storage processing in the present embodiment will be described with reference to FIG. 2.

The write processing starts when an application or the like operating on the CPU 111 requests storage of data (steps S200 and S201).

The file system unit 112 determines a length of requested data to be stored from an unstored portion to be stored by a next command. This length is a length corresponding to an integral multiple of a unit length requested for the storage processing for the SSD 120, and is a length equal to or less than a maximum length determined by the SSD 120. After the length is determined, a target portion to be stored by the next command is specified (step S202). Next, it is confirmed whether or not there is a free area for the target portion of a target length (step S203). This processing is performed by the file system unit 112 referring to information managed by the integrated unused block management unit 114.

When there is a sufficient free area (YES in step S203), the storage control unit 118 is requested to issue a command to write the target portion, and the storage control unit 118 generates a control command and then issues the control command to the SSD 120 via the I/F unit (CPU) 121A (step S204). This control command is accompanied by data of the target portion and the target length thereof.

When there is no sufficient free area (NO in step S203), the file system unit 112 instructs the integrated GC execution unit 117 to execute garbage collection (step S210). As a result, an invalid area is collected to secure an enough size free area. The garbage collection roughly includes six steps from step S211 to step S216. First, an area to be subjected to garbage collection is determined (step S211). This determination method is different for each garbage collection algorithm. The algorithm is determined by selection processing of the garbage collection algorithm executed by the selection unit 116 independently of this flow, and the algorithm is appropriately executed in step S211. As the target area, a plurality of areas may be selected at a time, or may be selected one by one.

When the target area is determined, the integrated GC execution unit 117 instructs the storage control unit 118 to issue a command to execute copy in the SSD 120. Based on this, the storage control unit 118 generates an internal copy command and issues the command to the SSD 120 via the I/F unit (CPU) 121A (step S212). This internal copy command is accompanied by information indicating the target area to be migrated and validity/invalidity of data in the area.

The SSD 120 that has received the internal copy command performs processing of copying valid data to an appropriate area by using the information of the target area passed together with the command and the information indicating validity/invalidity of the data in the area. At that time, processing of determining an address of a copy destination is performed in advance (step S215). When the copy processing is actually completed, the information held in the integrated management information storage unit 123 of the SSD 120 is updated, and a response is returned to the CPU 111 (step S216). This response includes a physical address of a migration destination area and valid/invalid information of each data stored in the migration destination area.

When receiving the response to the internal copy command, the integrated GC execution unit 117 on the CPU 111 notifies the integrated unused block management unit 114 and the integrated mapping management unit 113 of the physical address and the valid/invalid information included in the response respectively, and updates the information held in the meta information storage unit 119 (although not illustrated, the same processing as the processing described as steps S206 and S207 exists after YES in step S214 and before the write command is issued (step S204)).

When a sufficient free area can be secured by the series of processing (YES in step S214), the GC processing ends, the processing returns to the original processing, and a write command is issued (step S204). When a sufficient free area cannot be secured (NO in step S214), the processing returns to the target determination processing (step S211).

When receiving the write command issued by the CPU 111, the SSD 120 determines a write destination address and actually performs write processing (step S217). Thereafter, information held in the integrated management information storage unit 123 of the SSD 120 is updated, and a response is returned to the CPU 111 (step S218). This response includes a physical address of a write destination area which corresponding to the write destination address and valid/invalid information of the area.

When the response to the write command is received (step S205), the file system unit on the CPU 111 notifies the integrated unused block management unit 114 and the integrated mapping management unit 113 of the physical address and the valid/invalid information included in the response respectively, and updates the information held in the meta information storage unit 119 (steps S206 and S207).

Next, it is determined whether or not all the data designated as a write request has been written (step S208). If all the data designated as the write request is written (YES in step S208), the processing is completed. When unwritten data remains (NO in step S208), the processing returns to step S202.

### Information Managed by Meta Information Storage Unit 119 and Integrated Mapping Management Unit 113

In the description of the processing of updating the information managed by meta information storage unit 119 in steps S206 and S207 in FIG. 2, the relationship between the information in the file system unit 112 and the meta information storage unit 119 of the present embodiment will be described.

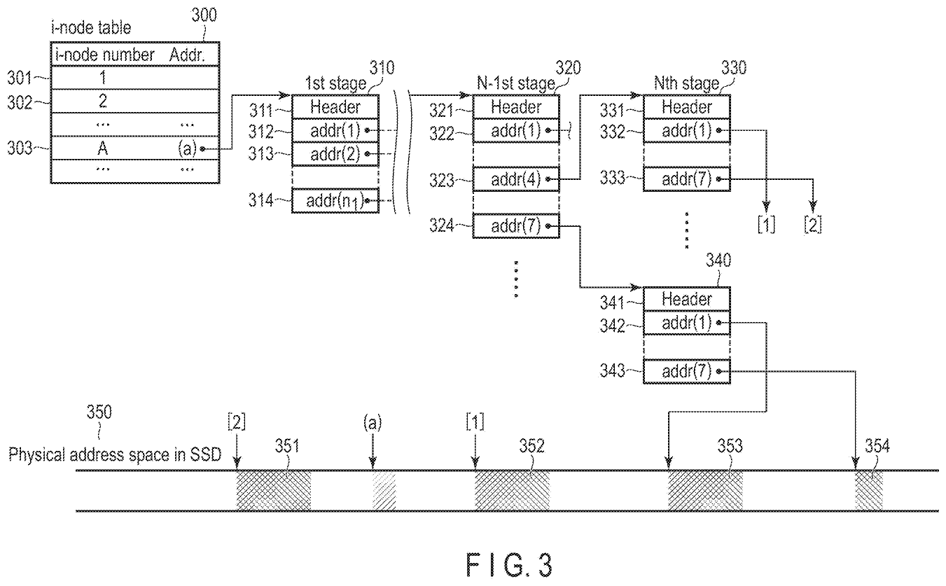

FIG. 3 schematically illustrates a structure of a file system provided by the file system unit 112. The file system unit 112 holds a file by using an inode table 300 that holds an address storing an inode and an extent management structure that holds a storage location of a file corresponding to the inode. At least a part of the inode table 300 is cached in the meta information storage unit 119 when the system is energized, and is written back to the SSD 120 at an appropriate timing. Note that an amount to be cached depends on a capacity of the meta information storage unit 119. In FIG. 3, entries indicated by 301 to 303 are cached.

The extent management structure has a tree structure, and is a data structure that efficiently manages from a file having a small size to a file having a large size. An intermediate management structure is called an extent index, and a management structure of a leaf is called an extent leaf. Each management structure has a header and one or more address storage areas following the header, and the address storage area refers to a storage location of the extent index of one layer below in a case of the extent index, and refers to a location on a physical address space configured by the nonvolatile storage units 1 to N of the SSD in a case of the extent leaf. Each management structure may be cached in the meta information storage unit 119, but is basically stored in any one of the nonvolatile storage units 1 to N of the SSD 120. For example, an extent index 310 indicated by an entry 303 of an inode number A is stored in a location of (a). In a case where it is desired to access a file managed by this management structure, the extent index 310 is read, and a next extent index is read from an entry therein, for example, the address (addr (1)) indicated by the first entry 312. This operation is repeated, and when it finally reaches the extent leaf, the physical address for accessing the actual area to be accessed is known. For example, in a case where a location corresponding to the addr (7) is accessed in a case where the extent leaf 330 is reached, the physical address [2] may be referred to.

The file system unit 112 of the present embodiment has such a management structure for the storage location, but this structure needs to be changed each time a file is updated. For example, when a new file is created, it is necessary to add an entry to the inode table 300 and appropriately construct the tree structure of the extent. When an existing file is overwritten, it is necessary to change the information of the storage location indicated by the extent leaf. Here, it should be noted that, due to the structure of the SSD including the SSD 120, a change to an existing file is made not by overwriting and updating but by writing at another location. Therefore, even if only some information in the file is updated, there is a possibility that an update occurs anywhere in the tree structure. Furthermore, since the tree structure itself is also stored on the SSD 120, the change of one extent leaf is propagated to its upper level.

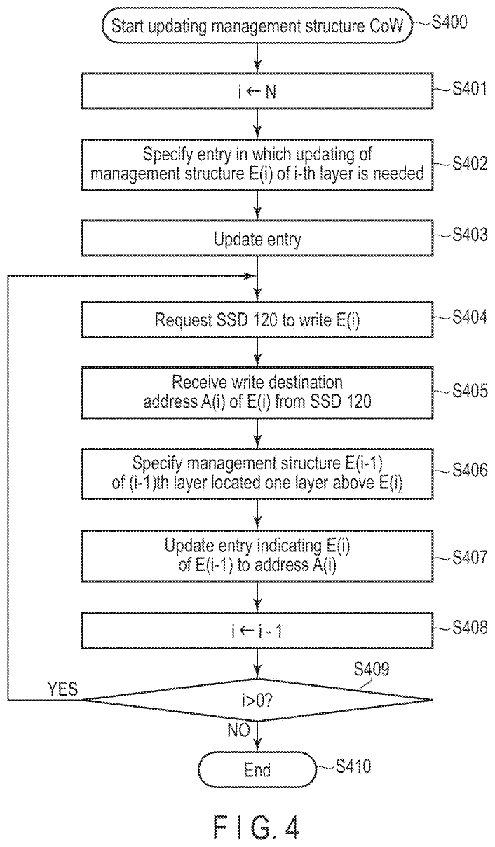

The integrated mapping management unit 113 has a function of performing this update processing and appropriately maintaining the management structure. FIG. 4 is a flowchart of updating a management structure described in step S206 of FIG. 2. This flow is called with a physical address A of the write destination area received from the SSD 120 in step S205 of FIG. 2 and the management structure (extent leaf) in which the change has occurred.

First, a variable i is initialized with the number of stages N of the management structure for managing an updated file (step S401). Note that the number of stages 0 represents an uppermost inode table. In the flow illustrated in FIG. 2, the physical address A changed at the time of executing step S205 and a management structure E (N) that managed the corresponding portion before writing are grasped. Following the initialization of the variable i, the corresponding entry of the management structure E (N) is specified (step S402) and its value is updated with A (step S403).

The management structure (extent leaf and extent index) with the updated entry is stored in the SSD 120 for non-volatilization. This step is performed by requesting the SSD 120 to perform writing the management structure and receiving a physical address A (i) specifying a location where the management structure is written (steps 5404 and S405), similarly to the storage of the data illustrated in FIG. 2. In a state where the physical address A (i) received as a response is held, a management structure E (i-1) which is located one layer above the stored management structure E (i) is specified and acquired (step S406).

The newly acquired management structure E (i-1) contains an old address of the management structure E (i) of which storage location has been changed to the address A (i). The old address is updated to the address A (i) of the new storage location (step S407).

Next, the variable i is subtracted by one (step S408). As a result, the hierarchy of the tree structure is moved up from a lowest level (leaf) toward a highest level (root). At this time, when the value of i is larger than 0 (YES in step S409), the processing returns to step S404 to write a layer one layer above the written layer. When the value of i is 0 (NO in step S409), it means that the inode table which is an uppermost management structure has been updated, and thus the processing ends (step S410).

In the series of processing, it is described that the updated entry is stored only in the SSD 120, but the updated result may also be temporarily held in the meta information storage unit 119. Further, the flowchart of FIG. 4 does not include processing of writing the uppermost inode table into the SSD 120. Since the inode table may be frequently updated, the file system unit 112 according to the present embodiment manages the inode table by a special method. This will be described later.

The above is the management structure update processing performed by the integrated mapping management unit 113.

### Information Managed by Meta Information Storage Unit 119 and Integrated Unused Block Management Unit 114

Next, management of an unused area required when the SSD 120 stores new information will be described. The information on the unused area is held in the SSD 120 and the meta information storage unit 119, and is maintained and managed by the integrated unused block management unit 114.

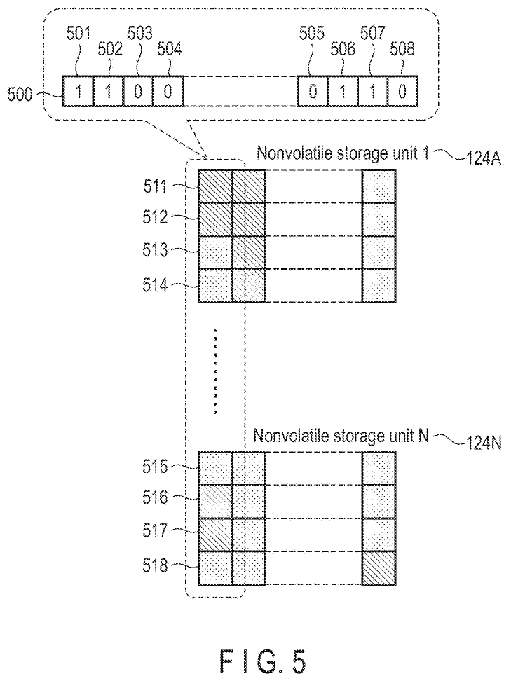

FIG. 5 is a schematic diagram of a management structure used when the file system unit 112 manages an unused area. FIG. 5 illustrates a state in which write units are provided for the nonvolatile storage units 1 (124A) to N (124N) that configure the SSD 120 (square portions provided inside the nonvolatile storage units 1 to N in FIG. 5), and a bitmap 500 is composed of bitfields corresponding to multiple write units. Each bitfield of the bitmap 500 holds a value (1 or 0) indicating validity or invalidity of the data held in the write unit, and an area 501 corresponds to a write unit 511, an area 502 corresponds to a write unit 512, and the like. Here, the bitmap 500 is described so as to straddle the nonvolatile storage unit 1 (124A) to the nonvolatile storage unit N (124N), but the bitmap may be generated in a narrower range or in a wider range.

This bitmap is stored in the SSD 120 similarly to the management structure related to the inode table and the extent described above, and is also temporarily held in the meta information storage unit 119. Further, the same information may be held in the integrated management information storage unit 123 of the SSD 120.

This information is also used to search for a free area inside the SSD 120 when writing is performed, but is also used to notify the SSD 120 of the free area and the invalid data area together with the internal copy command when the file system unit 112 executes garbage collection in step S213 of FIG. 2. The file system unit 112 selects an area to be migrated and erased to make a new free area, acquires the corresponding bitmap from the integrated unused block management unit 114 and the meta information storage unit 119, and notifies the validity/invalidity of the data therein (when the data is cached in the meta information storage unit 119, the data is acquired from the meta information storage unit 119, and when the data is not cached in the meta information storage unit 119, the data is read from the SSD 120 once based on the instruction of the integrated unused block management unit 114, and the data can be acquired after the data is cached in the meta information storage unit). At this time, one write unit may be notified, or a plurality of write units may be collectively notified. In any case, the bitmap is notified to the SSD 120 used as the latest information of validity/invalidity for the data in the notified area.

On the other hand, when validity/invalidity of data with respect to a write unit is changed by execution of an internal copy command or a write command, the SSD 120 may notify a bitmap together with a response of each command. Since the information to be stored in the bitmap can be calculated from the write destination address contained in the response of each command and the length of the written data, it is not always necessary to notify the bitmap. When notifying a bitmap, the integrated unused block management unit 114 updates the managed bitmap by using the notified bitmap. When not notifying a bitmap, the integrated unused block management unit 114 updates or generates a bitmap from the write destination address received from the file system unit 112 and the length of the written data, and stores the bitmap in the SSD 120. In addition, processing of caching in the meta information storage unit 119 is performed.

This bitmap information may be frequently updated similarly to the above-described inode table. Therefore, management is performed by a special method different from that for the above-described extent management structure. This will be described later.

### Management/Storage Method for Uppermost Management Structure: Special Area is Provided and Stored, and Storage Location is Managed Using Conversion Table

As described in FIGS. 3 and 4, a method of managing and storing an uppermost portion of an extent management structure that manages a location where data is actually stored will be described. This information is frequently updated, and is served as a starting point for searching for the data on the SSD 120. Therefore, it is desirable to be managed such that it can be reached from a fixed starting point. In the present embodiment, a method is used in which a special area is provided and stored on the SSD 120, the information is held by using a logical address in the file system unit 112, and conversion into a physical address is performed by using a conversion table.

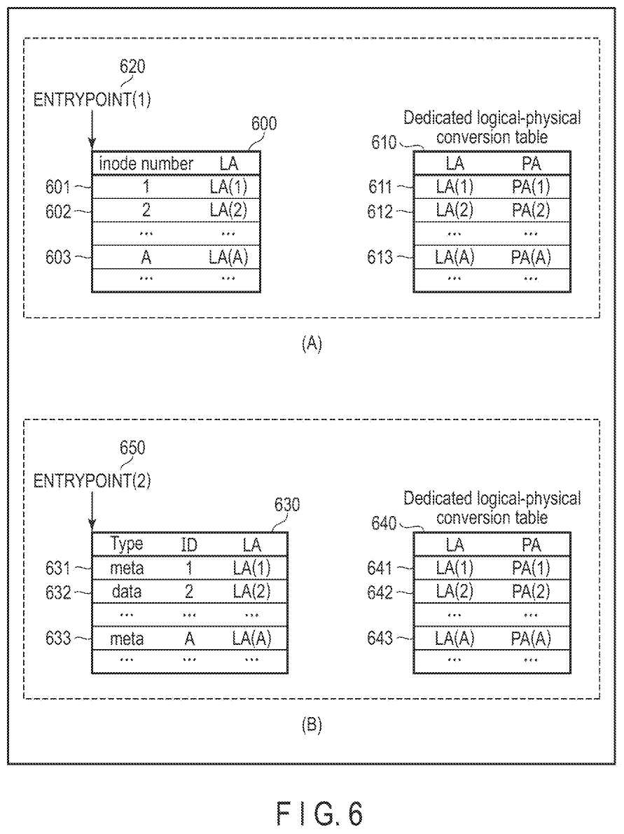

FIG. 6(A) illustrates an implementation example. It is configured with an inode table 600 in which addr. column of the inode table 300 illustrated in FIG. 3 is changed to an LA (logical address) column and a dedicated logical-physical conversion table 610 that converts the LA (logical address) into a PA (physical address). The inode table 600 is made to be fixedly accessible via a dedicated pointer 620 called ENTRYPOINT agreed between the file system unit 112 and the SSD 120. Note that since the number of necessary inodes is determined at the time of creating the file system, the sizes of these two tables are fixedly determined, and reading can be appropriately performed when the starting point of reading is determined. It is assumed that ENTRYPOINT holds the physical address of the inode table 600 by using a dedicated nonvolatile memory (not illustrated in FIG. 1).

The inode table 600 and the dedicated logical-physical conversion table 610 are read from the SSD 120 via ENTRYPOINT and developed in the meta information storage unit 119 when the file system unit 112 and the SSD 120 start operating when the system is started. Here, a method of realizing by using two tables of the inode table and the dedicated logical-physical conversion table has been described. However, both tables may be integrated into one table, or a large table for the entire area may be divided into a plurality of small tables (for example, for each specific capacity) and managed.

### Management/Storage Method for Bitmap

As described above with reference to FIG. 5, the bitmap is also managed in a special manner. Specifically, the management is performed by using the dedicated area similarly to the contents described in “Management/Storage Method for Uppermost Management Structure”. This area may be the same as the area holding the uppermost management structure, or a different area may be secured.

FIG. 6(B) illustrates an implementation example. As a difference from FIG. 6(A), a field of “type” is added to the management table. This field is a field representing the use of the bitmap, “meta” is a bitmap expressing validity/invalidity of an area in which information other than user data is stored, and “data” is a bitmap expressing validity/invalidity of an area in which the user data is stored. As described above, since the management structure that is not the uppermost is stored and managed by using the same area as the user data, this field exists. Note that the management table itself may be divided into two and managed separately without using this field. At that time, another ENTRYPOINT 650 may be prepared.

The “ID” field is an identifier for specifying an area expressed by a bitmap. Here, a serial number for an area used by the SSD 120 to store data is exemplified as an ID, but an uppermost part of the physical address of the area expressed by the bitmap can also be used.

### Regarding Selection of Garbage Collection Algorithm

One advantage of integrating the management information of the file system and the management information of the SSD is that the information of the file system is easily used for garbage collection executed in the SSD. Details thereof will be described below.

In using the management information of the file system, the CPU 111 of the present embodiment includes a measurement unit 115, a selection unit 116, and an integrated GC execution unit 117. The measurement unit 115 realizes a function of monitoring the operation of the application on the SSD through the file system unit 112, the integrated mapping management unit 113, and the integrated unused block management unit 114, and a function of providing the monitoring result to the selection unit 116. For example, information such as an I/O amount (total amount of volumes read by read commands/number of execution times of read commands), a ratio of valid/invalid data, an update frequency (a frequency at which an update occurs and migration to another area occurs), and an I/O occurrence interval is measured for each area. For timing information necessary for measuring the frequency or the occurrence interval, a clock or the like may be used by the CPU 111.

The measurement data measured by the measurement unit 115 is held in the meta information storage unit 119. At the time of storage, a measurement value may be stored as it is, or may be stored after being deformed by performing some calculation. For example, in a case where an occurrence of an update is monitored, instead of recording an occurrence time itself, a difference from the time of a previous occurrence may be recorded as an update interval, or the number of occurrences for classification obtained by dividing the time of the occurrence into a certain amount may be recorded to create a frequency distribution table. At the time of storage, it may be sequentially recorded in an array or the like secured in the meta information storage unit 119, or may be stored by using a mechanism such as a database.

The measurement unit 115 has a function of reading and responding the measurement data measured and stored in response to an external request. In addition, a function of notifying a registered functional element when a condition registered in advance is satisfied may be provided.

The selection unit 116 selects an effective garbage collection algorithm for an area used by the application based on the measurement data of the measurement unit 115. Selection condition (algorithm selection conditions and GC programs to be executed (description of conditions and algorithms for selecting an area to be migrated)) of a specific candidate garbage collection algorithm is held in advance by the selection unit 116. The selection condition is a condition for determining whether or not the GC program can be selected based on the measurement data recorded by the measurement unit 115. For example, at least one condition such as the number of execution of write commands in a target area within a certain period of time, frequency of executing write command, the number of invalid areas, and a ratio between a total amount of valid units in an area and a total amount of invalid units in the area is set. The conditions may be set by combining a plurality of conditions in a form of a logical product or a logical sum.

The selection processing of the GC program by the selection unit 116 is executed when the file system unit 112 determines that execution of garbage collection is necessary. The selection unit 116 receives at least one area as a migration candidate by garbage collection from the file system unit 112, and refers to the measurement data recorded by the measurement unit 115 for the area. Thereafter, a best GC program is selected for the designated area.

Here, each GC program has a priority assigned in advance in order to determine the “best”. When a plurality of GC programs satisfy the selection condition, a GC program having a highest priority is selected. When there is no GC program satisfying the selection condition, a GC program set as a default is selected.

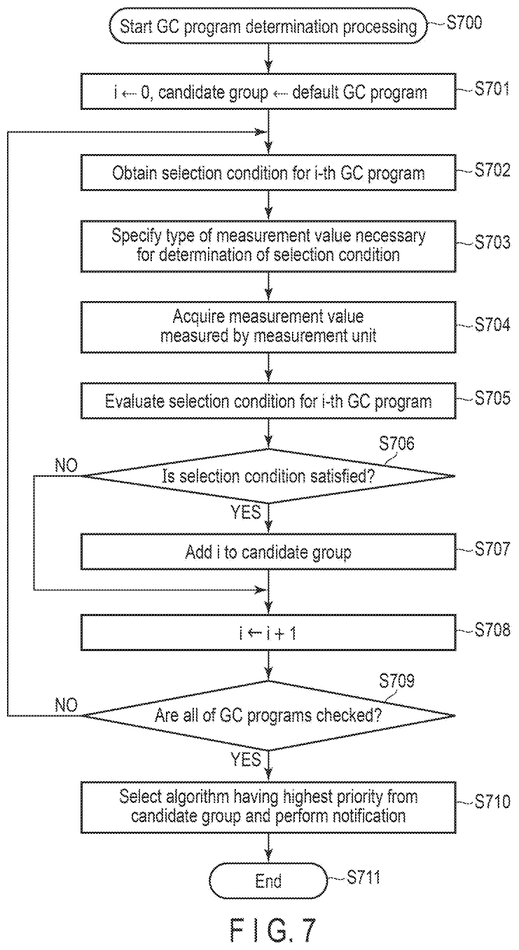

The selection unit 116 notifies the integrated GC execution unit 117 of the finally selected GC program and the migration candidate area notified from the file system unit 112. An example of an operation flow of the selection unit 116 is as illustrated in FIG. 7. Here, a flow in which the priority is compared after a candidate of the GC algorithm is extracted is described. However, an algorithm in which only an algorithm having the highest priority is held while being evaluated may be used, and details of the selection method are not subject to the present embodiment.

Note that the file system unit 112 may divide the area to be the migration candidate into a plurality of candidate groups and request the selection unit 116 to select the GC program for each of the candidate groups. For example, the processing of specifying a connection between the areas in which the write request is generated by using the structure (for example, a directory) of the file system and obtaining the candidate group is added before or after step S701 in FIG. 7. Then, the acquisition of the measurement values performed in steps 5703 and 5704 is changed so as to be limited to the measurement values for the target candidate group. Then, the selection unit 116 selects the GC program for each candidate group, and notifies the integrated GC execution unit 117 of the selected GC program and the migration candidate area included in the candidate group.

The integrated GC execution unit 117 executes the garbage collection by referring to the migration candidate of the garbage collection and the GC program notified from the selection unit 116, and information of the integrated mapping management unit 113 or the integrated unused block management unit 114. First, an algorithm included in the GC program is executed to determine a migration source area to be actually migrated from the migration candidate area. Then, an internal copy command is issued to the SSD 120 with a bitmap indicating an area validity/invalidity for the data of the migration source area, and processing of receiving the result is repeated until a free area can be secured.

### Timing of Selecting Garbage Collection Algorithm and Executing GC

In the flowchart of FIG. 2 and the above description, in the present embodiment, the garbage collection is executed when a sufficient free area cannot be secured by the write processing. However, the selection of the GC program and the garbage collection may be executed at other timings. For example, at a timing when there is no I/O via the file system, the processing may be executed to secure a continuous free area in advance for the purpose of speeding up future write processing. The GC program selection processing at this time may be executed in a similar manner to the selection processing performed when a sufficient free area cannot be secured due to writing, or may be executed with reference to another condition. Therefore, one GC algorithm may be able to hold a plurality of selection conditions, or may be realized as a GC algorithm selected only under a specific state by including a condition (for example, when the I/O has not been executed for a certain period of time or more, when there is a pending write request, or the like) related to the processing state of the I/O in the selection conditions.

In addition, as a result of the measurement by the measurement unit 115, in a case where a value exceeding a predetermined threshold is observed in the measurement unit 115 or a difference between consecutive observed values exceeding the threshold is observed, the measurement unit may notify the selection unit 116 or the integrated GC execution unit 117 to execute the garbage collection. In a case where the selection unit 116 is notified, an optimal GC program is selected by using the observed area as a migration candidate area, and GC is finally executed. In a case where the integrated GC execution unit 117 is notified, an already selected garbage collection algorithm or a default garbage collection algorithm is applied by using the observed area as a migration candidate area.

### Selection of Migration Source and Migration Instruction to SSD in GC Program

Each GC program holds at least one condition for specifying migration source areas to be actually migrated from the given migration candidate areas. As this condition, for example, it is conceivable to select an area in which the number of executing write commands per unit time is equal to or greater than a threshold from a certain area, an area in which the ratio of invalid data against the capacity of the area is equal to or greater than a threshold, an area in which the ratio of continuous areas is equal to or less than a threshold, an area in which a bit error rate (when the correction rate by the error correction code can be referred to from the outside of the SSD, the correction rate may or may not be considered) at the time of reading is equal to or greater than a threshold, or the like. The GC program specifies an area matching these conditions as the migration source area, and instructs the migration with respect to the SSD.

### Regarding Read and Other Operations

In addition to writing, an operation of reading data and other operations are issued to the SSD. However, in the present embodiment, since there is no particular change in these operations, a detailed description thereof will be omitted here. Hereinafter, in each embodiment extending the present embodiment, the same applies to a case where there is no particular reason.

### Summary of First Embodiment

The above is the first embodiment. By integrating the management information of the file system and the management information of the SSD, it is possible to realize an efficient information storage device and a system by eliminating duplication of similar functions. In addition, the integration enables selection of a GC program utilizing information of a file system, and enables execution of a GC more suitable for stored information.

### Second Embodiment (Modification to First Embodiment)

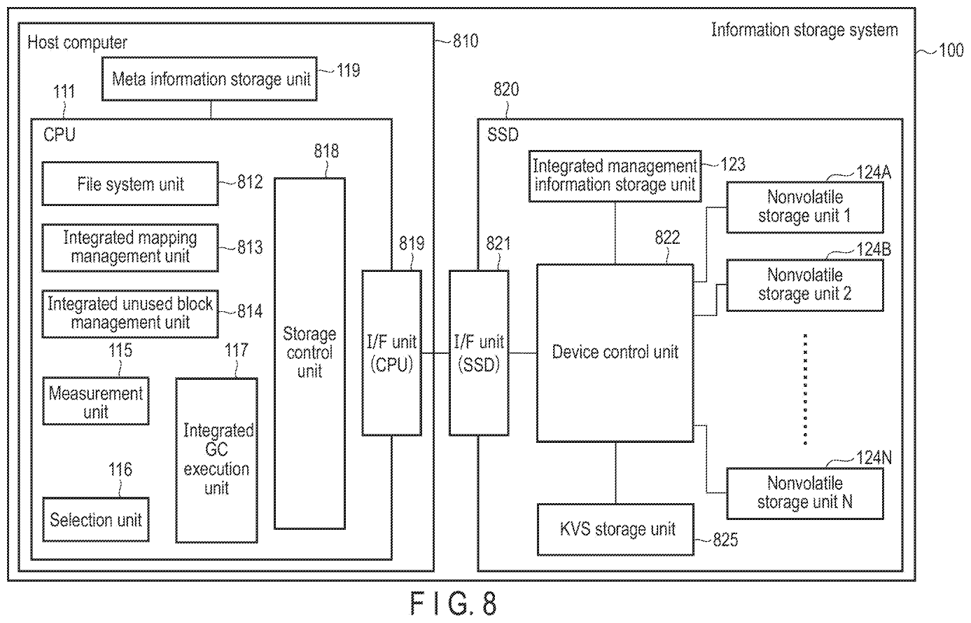

A second embodiment in which the uppermost portion of the management structure and the bitmap portion described in the first embodiment are changed to be managed by another means (key-value store method) will be described. FIG. 8 illustrates a block diagram of the present embodiment. Since it is a modification of the first embodiment, the same number is assigned to a portion where the function does not change.

Changes on an SSD 820 side are as follows. A KVS storage unit 825 that holds data by a key-value store method is added to the SSD 820. In order to cope with this processing, a device control unit 822 and an I/F unit (SSD) 821 are extended. Specifically, the I/F unit (SSD) 821 includes an interface using a protocol corresponding to a key-value store in addition to an interface using an NVMe protocol used by a normal SSD. It may be physically multiplexed into one interface, or may be realized as separate interfaces. Here, it is illustrated that multiplexing is performed on one physical interface.

The device control unit 822 interprets a difference in the protocol, and executes I/O processing on the nonvolatile storage unit 1 (124A) to the nonvolatile storage unit N (124N) in the case of reading and writing data according to the first embodiment. In a case of a protocol corresponding to the key-value store, the command (set, get, and the like) is interpreted and a value (data) corresponding to the key is stored or read in the KVS storage unit 825. As the KVS storage unit 825, the same NAND flash memory as the nonvolatile storage units 1 to N may be used, or another memory may be used. Here, the KVS storage unit is physically added, but a part of the nonvolatile storage units 1 to N may be secured as a dedicated area and logically assigned.

On the other hand, changes on the host computer side are as follows. As the interface I/F unit (SSD) 821 of the SSD 820 is changed, the I/F unit (CPU) 819 is also changed correspondingly. In addition, a storage control unit 818 that converts an access request to the SSD 820 on the host computer 810 into an appropriate command also changes the command generated in accordance with the change of the SSD 820. Specifically, a response to a command for reading and writing data by the key-value method is added.

In each processing of the file system unit 812, the integrated mapping management unit 813, and the integrated unused block management unit 814, a key is assigned to the uppermost management structure or bitmap, and the management structure or bitmap is stored as a value corresponding to the key in the SSD 820 and non-volatilized. At this time, the command corresponding to the I/O request of the key-value store method generated by each unit is converted into an appropriate command by the storage control unit 818 as described above. The point that the information read during the operation is cached in the meta information storage unit 119 is the same as the first embodiment. The value of the key may be created by combining a flag indicating the distinction between the management structure and the bitmap, an identifier corresponding to a position managed by the bitmap, and the like.

The above is the second embodiment. By managing a part of management information in the dedicated KVS area, it is possible to reduce an overhead of managing or referring to the conversion table.

### Third Embodiment (Modification to First Embodiment)

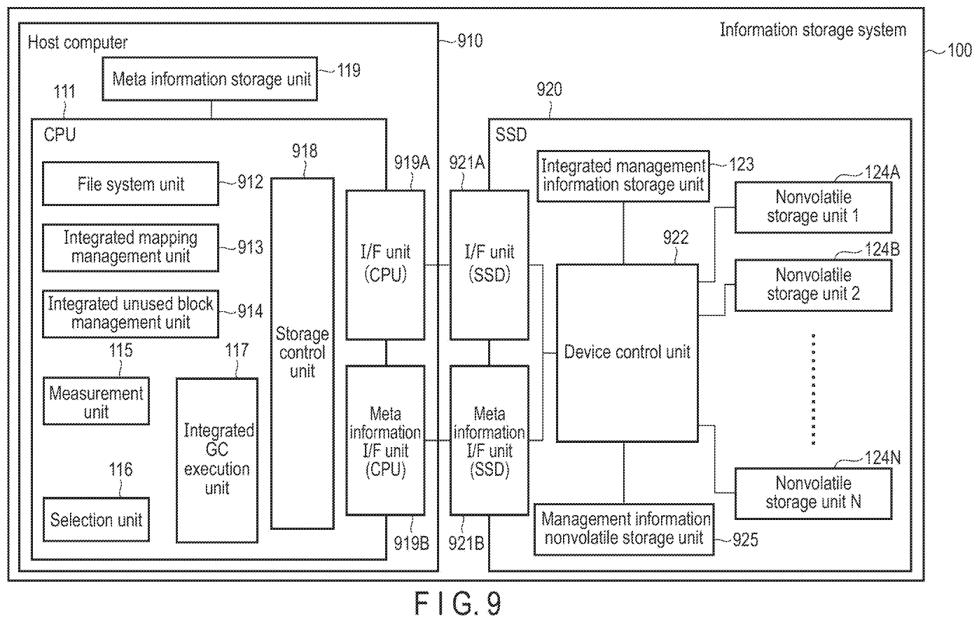

A third embodiment in which the uppermost portion of the management structure and the bitmap portion described in the first embodiment are changed to be managed by another means (byte accessible nonvolatile memory) will be described. FIG. 9 illustrates a block diagram of the present embodiment. Since it is a modification of the first embodiment, the same number is assigned to a portion where the function does not change.

Changes on an SSD 920 side are as follows. A management information nonvolatile storage unit 925 configured by a nonvolatile memory that can be read and written in byte units or in units smaller than the nonvolatile storage units 1 to N is added to the SSD 920. Accordingly, a device control unit 922 is changed so as to be able to access the storage unit. In addition to an interface I/F unit (SSD) 921A using an NVMe protocol used by a normal SSD, an interface I/F unit (SSD) 921B using a protocol suitable for the management information nonvolatile storage unit 925 is also provided. Although an example in which it is divided into two interfaces is illustrated here, the two interfaces may be multiplexed into one physical interface.

On the other hand, changes on the host computer side are as follows. With the change to the interface I/F unit (SSD) 921A and a meta information I/F unit (SSD) 921B of the SSD 920, the interface on the host computer side is also changed to an I/F unit (CPU) 919A and a meta information I/F unit (CPU) 919B. In addition, a storage control unit 918 that converts an access request to the SSD 920 on the host computer 910 into an appropriate command also changes the command generated in accordance with the change of the SSD 920. Specifically, when the meta information is read from or written to the SSD 920, a function of generating a LOAD/STORE command (or a command similar thereto) so as to access a normal memory device and transmitting the generated command to the SSD 920 via the meta information I/F unit (CPU) 919B is added. The command for the normal SSD included in the first embodiment is performed via the I/F unit (CPU) 919A.

Since each piece of information is non-volatilized in the management information nonvolatile storage unit 925 of the SSD 920, the address of the ENTRYPOINT and the address of the inode table directly hold the physical address of the management information nonvolatile storage unit 925. Therefore, the conversion table illustrated in FIG. 6 is unnecessary. When the uppermost management structure or bitmap is referred to, each processing of a file system unit 912, an integrated mapping management unit 913, and an integrated unused block management unit 914 checks whether or not there is cached information in the meta information storage unit 119, and performs processing of reading the information from the management information nonvolatile storage unit 925 when the information is not cached.

The above is the third embodiment. Since a part of the management information is stored in a readable/writable nonvolatile memory in byte units inside the SSD 920 or in units smaller than the nonvolatile storage units 1 to N, the meta information can be read/written without address conversion or association with a key-value.

### Fourth Embodiment (Addition of Cache Coherency Bus to First Embodiment: Part 1)

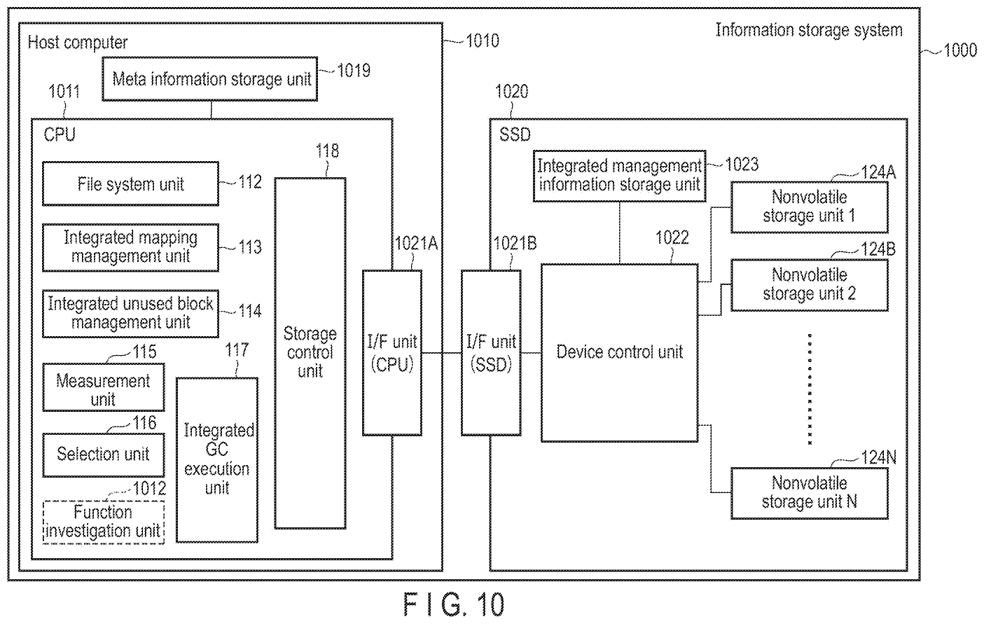

Next, a fourth embodiment will be described. The present embodiment is a modification of the first embodiment, and a bus coupling the host computer and the SSD has cache coherency. FIG. 10 shows a block diagram of the present embodiment. The configuration is almost the same as the block diagram for the first embodiment, and the elements having different functions from those in FIG. 1 are given new numbers.

An information storage system 1000 includes a host computer 1010 and an information storage device 1020 (hereinafter, an SSD 1020). The host computer 1010 includes a CPU 1011 having an I/F unit (CPU) 1021A coupled to a bus having cache coherency. The other elements of the CPU 1011 are the same as those of the first embodiment. A meta information storage unit 1019 is affected by the cache coherency function of the bus.

The SSD 1020 is an SSD having an I/F unit (SSD) 1021B coupled to the bus having the cache coherency described above, and a device control unit 1022 is changed with the change of the interface. Further, an integrated management information storage unit 1023 functions as a cache for meta information storage unit 1019 coupled to the host CPU 1011. Other constituent elements of the SSD 1020 are the same as those of the first embodiment. In FIG. 10, there is no volatile storage unit that is not affected by the cache coherency function on the SSD 1020 side, but there may be a volatile storage unit used in a temporary area or the like.

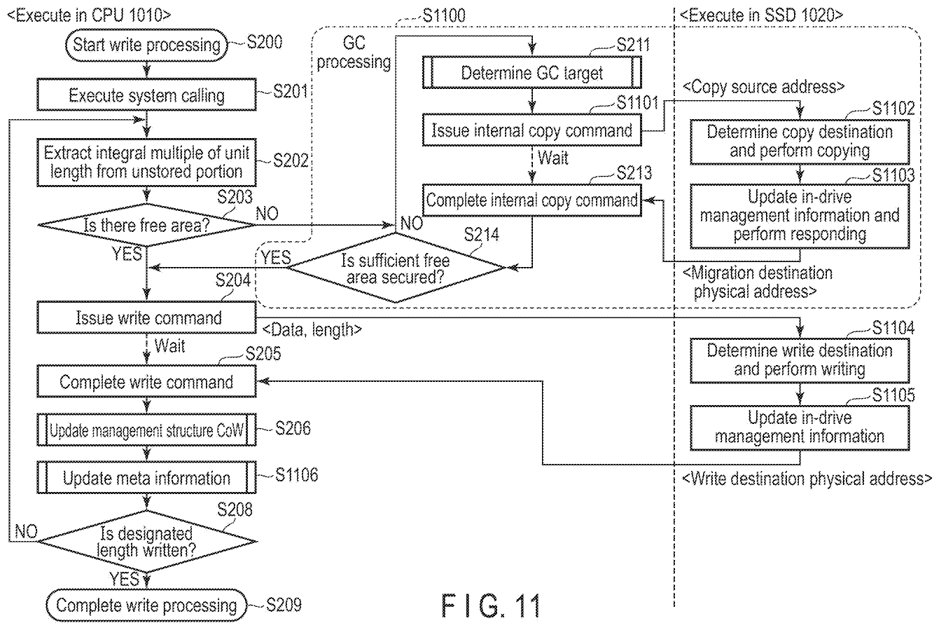

FIG. 11 is an operation flow of an information storage system 1100 of the present embodiment. However, it is based on the first embodiment illustrated in FIG. 2, and a portion affected by coupling via a bus having a cache coherency function is changed. Specifically, in a GC processing step S1100, step S1101 of issuing an internal copy command, step S1102 of determining and copying a copy destination according to the internal copy command, step S1103 of updating and responding to in-drive management information, step S1104 of determining a write destination address and writing data in a write destination area which corresponding to the write destination address upon receiving a write command, step S1105 of updating the in-drive management information based on writing, and step S1106 of updating meta information associated with writing are performed.

In some steps, parameters explicitly notified between the CPU 1010 and the SSD 1020 are omitted. These pieces of information are implicitly shared by using the cache coherency function. In step S1101, the CPU 1010 issues an internal copy command, but is changed so as not to notify valid/invalid information of an area serving as a copy source at that time. Similarly, in steps 51103 and 51105, the validity/invalidity information of a migration destination or a write destination area is changed so as not to be notified as a response. In step S1102 of executing the internal copy command, the validity/invalidity information of the area serving as the copy source is not received together with the command, but the information is acquired with reference to the integrated management information storage unit 1023. Conversely, in the responses in steps 51103 and S1105, the result is reflected on the CPU 1010 side by updating the information in the SSD 1020.

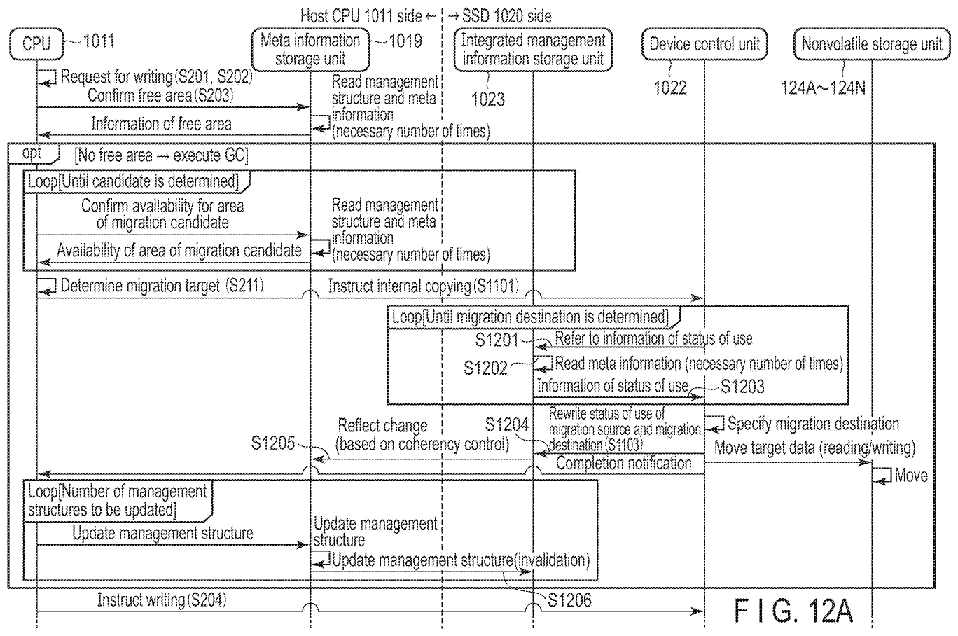

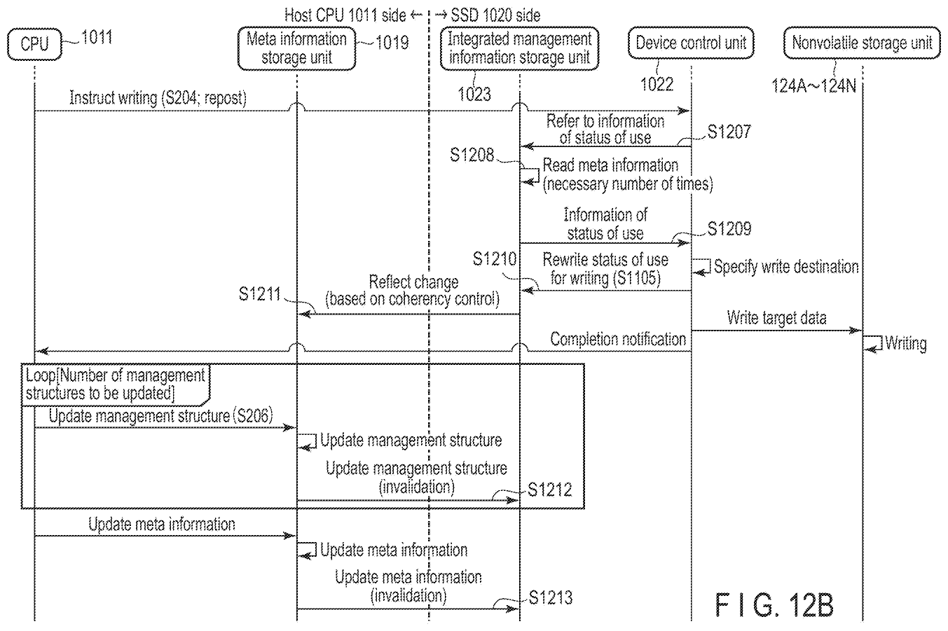

FIGS. 12A and 12B are sequence diagrams illustrating the operation (FIG. 11) in the present embodiment divided into respective elements. The steps affected by the cache coherency function, which is a feature of the present embodiment, are designated by the S12?? symbol. Steps S1201 to S1203 and S1207 to S1209 are steps of obtaining a value with reference to the cache on the SSD 1020 side. At this point, in a case where the information corresponding to integrated management information storage unit 1023 that is the cache is not stored, it is necessary to read the corresponding information from meta information storage unit 1019 coupled to the CPU 1011 via the interface.

Steps S1204, S1205, S1210, and S1211 illustrate a state in which the update of integrated management information storage unit 1023 that is the cache is reflected in meta information storage unit 1019. In FIGS. 12A and 12B, an arrow is drawn from the integrated management information storage unit 1023 toward meta information storage unit 1019, but actually, a cache control function (not illustrated) incorporated in the CPU 1011 or the device control unit 1022 is appropriately interposed to synchronize the update data. In addition, in steps S1206, S1212, and S1213, cache invalidation processing is performed by updating the management structure and the meta information by the CPU 1011. Although it is described as an invalidation in this figure, it may be implemented to notify the cache of a new value in association with the invalidation. This notification processing may be realized as hardware by the above-described cache control function, or may be notified to the SSD 1020 together when software (in this case, the integrated mapping management unit 113 or the integrated unused block management unit 114 that updates the meta information storage unit 1019) executed on the CPU 1011 performs update.

### Read and Non-Volatilization of Management Structure and Metadata, and Conversion of Data Structure

As described above, in the present embodiment, the meta information storage 1019 manages the management structure and metadata of the file system with the highest priority, and the integrated management information storage 1023 follows the management results of the meta information storage 1019. However, while the present system is stopped, the management structure and the metadata of the file system are stored in the nonvolatile storage units 1 to N (124A to 124N) for persistence. Therefore, when the system starts operating, the CPU 1011 appropriately reads the management structure and the metadata from the SSD 1020, develops the management structure and the metadata on the meta information storage unit 1019, and holds the management structure and the metadata. When the operation is started, the information in the meta information storage unit 1019 is changed, and these are persisted in the nonvolatile storage units 1 to N (124A to 124N) at an appropriate timing. On the other hand, integrated management information storage unit 1023 operates as a cache of meta information storage unit 1019, and thus, it is not necessary to persist the information held therein.

In addition, it is not necessary to maintain a data structure on the premise of persistence when the data is developed and held on the meta information storage unit 1019. In the present embodiment, since the SSD that cannot be overwritten and updated is used, it is necessary to have a data structure suitable for appending when the SSD is stored in the nonvolatile storage units 1 to N (124A to 124N), but the structure may not be maintained while the SSD is developed in the meta information storage unit 1019. For example, a structure on the premise of overwriting and updating on the memory may be adopted. The integrated mapping management unit and the integrated unused block management unit have a data structure conversion function, and can cope with this by performing appropriate data structure conversion and then developing or non-volatilizing the data structure. Note that, here, as an example, a data structure obtained by serializing (serialization; continuously disposing from a head to an end of the data structure according to a certain rule) the data structure as illustrated in FIG. 3 as a data structure suitable for appending, and as a data structure on the premise of overwriting update, a state in which the data structures as illustrated in FIG. 3 are disposed in a distributed manner on a memory and are coupled to each other by a pointer will be described.

Furthermore, a master-slave relationship described above eliminates the need to reflect updates to the management structure and the metadata during operation on the SSD side each time. As a result, an update frequency and an update amount of the nonvolatile storage units 1 to N (124A to 124N) configuring the SSD are reduced, and the life of the SSD can be expected to be extended.

### Specific Memory Devices of Meta Information Storage Unit and Integrated Management Information Storage Unit

Various combinations are conceivable for the memory devices that realize the meta information storage unit and the integrated management information storage of the present embodiment. For example, a DRAM or an SCM may be used on the CPU side. The DRAM is more advantageous from the viewpoint of the life and the operation speed according to the update frequency and amount, but may be realized by using an SCM in which the capacity can be secured at a lower cost than the DRAM depending on the management structure to be held and the amount of metadata. In addition, the DRAM may be used as a cache of the SCM by using both the DRAM and the SCM.

On the other hand, as the integrated management information storage unit, an SRAM, a DRAM, an SCM, an SLC NAND flash, or the like can be used. The SLC NAND flash is inferior to other options in terms of throughput and latency, but is considered to be advantageous in terms of cost. Further, when the nonvolatile storage units 1 to N are virtually used as the SLC NAND flash, it is advantageous not only in terms of cost but also in terms of a mounting area on a circuit board. Further, although the integrated management information storage unit is collectively described in the series of description, different memory devices may be used to store the management structure and the metadata. For example, the SCM may be used to store a management structure having a large amount of data, and the SRAM or DRAM may be used to store metadata having a high update frequency. Further, similarly to the CPU side, a plurality of memory devices may be combined to utilize the other memory device as a cache for one memory device. When using as a cache, it can be used such that a management structure having a large amount of data and a high update frequency is stored in the DRAM, and other management structures are stored in the SCM.

### Example of Bus

In the present embodiment, a bus having cache coherency is adopted, and a computer express link (CXL) can be exemplified as an example. There are several specifications for the CXL, and CXL.cache is available here. The CPU 1011 functions as a CXL host and the SSD 1020 functions as a memory device of type 1 or type 2 and is controlled by the CXL.cache.

In addition, the software operating on the CPU side may be implemented in a form corresponding to all the embodiments described above. In that case, a mechanism for investigating functions implemented by the SSD is executed while the CPU recognizes the SSD in a boot sequence. For this, for example, a method is conceivable in which a function investigation unit is added to the CPU, and the function investigation unit (1012 in FIG. 10) transmits an investigation command to the SSD to acquire a list of implemented functions. An appropriate command defined by the specification of the bus may be used to realize this function. As an example, a method of investigating a function implemented by the SSD using CXL.io or investigating a capacity of the integrated management information storage unit can be considered. The information acquired by the function investigation unit 1012 may be held in the meta information storage unit 1019, and the file system unit 112, the integrated mapping management unit 113, or the integrated unused block management unit 114 may refer to the information as necessary.

### Fourth Embodiment Based on Second and Third Embodiments

Although the above description has been described by using the block diagram based on the first embodiment, the modification according to the present embodiment can also be applied to the second and third embodiments.

In the second embodiment, the update of the management structure and the meta information in a key-value format with respect to the SSD 820 is replaced with the update with respect to the key-value store constructed on the meta information storage unit 1019. In addition, a step of reading an appropriate amount of the management structure and the meta information that can be stored in the meta information storage unit 1019 from the SSD 820 when the operation is started and developing the management structure and the meta information in the meta information storage unit 1019, a step of updating the developed information, and a step of non-volatilizing the management structure and the meta information in the SSD 820 at an appropriate timing may be executed.

In the third embodiment, the updating of the management structure and the meta information performed via the meta information I/F unit (SSD) 921B of the SSD 920 is replaced with the processing of updating the meta information storage unit 1019. In addition, a step of reading an appropriate amount of the management structure and meta information that can be stored in the meta information storage unit 1019 from the management information nonvolatile storage unit 925 of the SSD 920 when the operation is started and developing the management structure and the meta information in the meta information storage unit 1019, a step of updating the management structure and the meta information, and a step of non-volatilizing the management structure and the meta information in the management information nonvolatile storage unit 925 of the SSD 920 at an appropriate timing may be executed.

### Summary of Fourth Embodiment

Since the CPU 1011 and the SSD 1020 are coupled via the bus having the cache coherency function in this manner, it is not necessary to manage the update of the management information common to both portions by software. In addition, since update or invalidation is performed by hardware, improvement in processing speed can also be expected. Further, since it is not necessary to notify the SSD side of the update to the management structure and the metadata in operation each time, it is possible to expect a long life.

### Fifth Embodiment (Memory in SSD is Directly Referred to from CPU)

### Block Diagram and Operation Outline

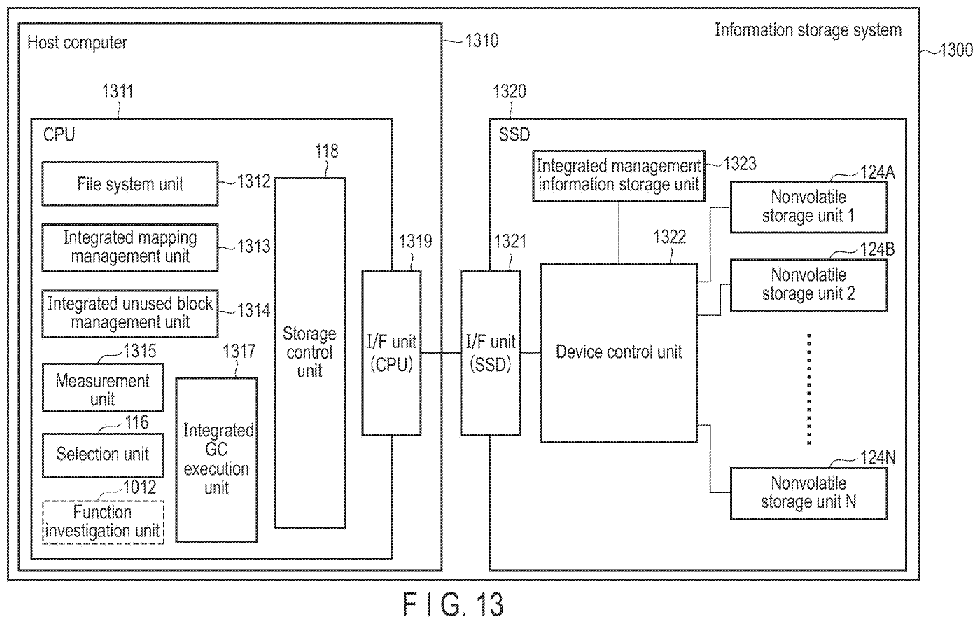

The present embodiment is a modification of the fourth embodiment. A block diagram is illustrated in FIG. 13. This block diagram is substantially the same as FIG. 10, and differs from FIG. 10 in that there is no meta information storage unit on the CPU side, and functions of a part of components are different. In the fourth embodiment, the CPU 1011 and the SSD 1020 are coupled by using the bus having the cache coherency function, and the meta information storage 1019 manages the management structure and metadata of the file system with the highest priority, and the integrated management information storage 1023 follows the management results of the meta information storage 1019. On the other hand, in the present embodiment, a CPU 1311 directly refers to an integrated management information storage unit 1323 in an SSD 1320 to facilitate management of the two components. Note that a temporary storage unit used by the program on the CPU for operation may be provided instead of the meta information storage unit.

As an example of a bus for realizing the configuration of FIG. 13, a CXL (in particular CXL.mem) is given. A part of the SSD 1320 functions as a CXL device, and the integrated management information storage unit 1323 is a memory that can be operated from the CPU 1311. Although only a set of interfaces of an I/F unit (CPU) 1319 and an I/F unit (SSD) 1321 is illustrated in FIG. 13, an interface for executing I/O as a storage and an interface for accessing the integrated management information storage unit 1323 may be physically divided.

When the SSD 1320 starts operating, a file system unit 1312 on the CPU 1311 side performs initialization processing of developing information held in the SSD 1320 on the integrated management information storage unit 1323. By this processing, the management structure and the metadata stored in the nonvolatile storage units A to N (124A to 124N) are read and appropriately developed (stored) on the integrated management information storage unit 1323. At this time, it is not necessary to read and develop the management structure and the metadata corresponding to all the file systems held by the SSD 1320. In consideration of a capacity of the integrated management information storage unit 1323 and a time required for the initialization processing, only a part necessary for starting the operation is read and developed (for example, only minimum information that can be referred to as information on a root directory of the file system is developed).

When the development of the necessary information is completed, the operation is started under the instruction of the CPU 1311 similarly to the embodiments described above. However, each element of the file system unit 1312, an integrated mapping management unit 1313, an integrated unused block management unit 1314, and a measurement unit 1315 on the CPU 1311 operates by referring to information stored in the integrated management information storage unit 1323 in the SSD 1320. When the desired information is not developed in the integrated management information storage unit 1323, the CPU 1311 reads the management structure and the metadata that have not been developed and stores the read management structure and metadata in the integrated management information storage unit 1323. At this time, a part of the management structure and the metadata may be non-volatilized (written back to the nonvolatile storage units 1 to N (124A to 124N)) before being stored.

### Sequence Diagram

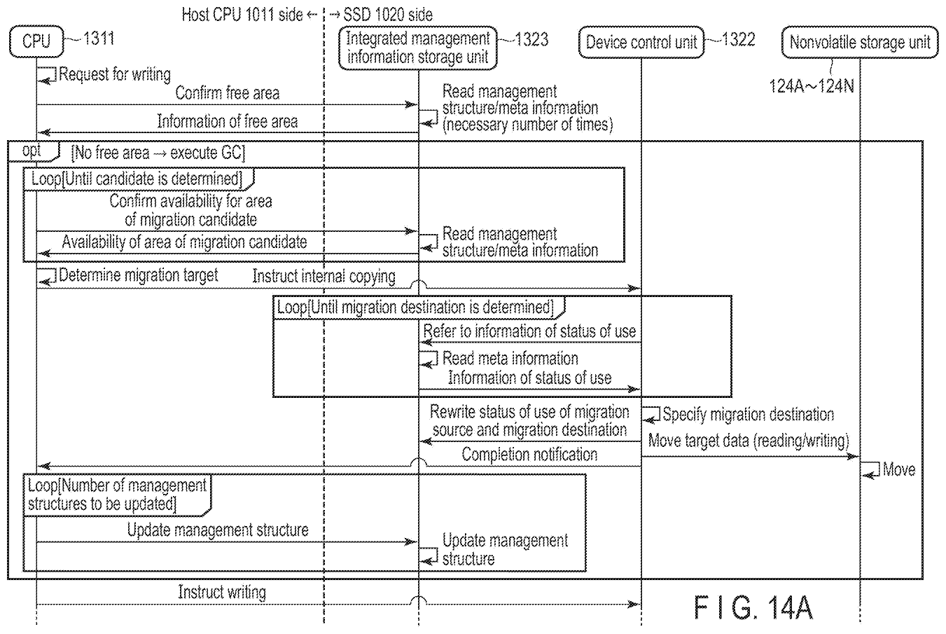

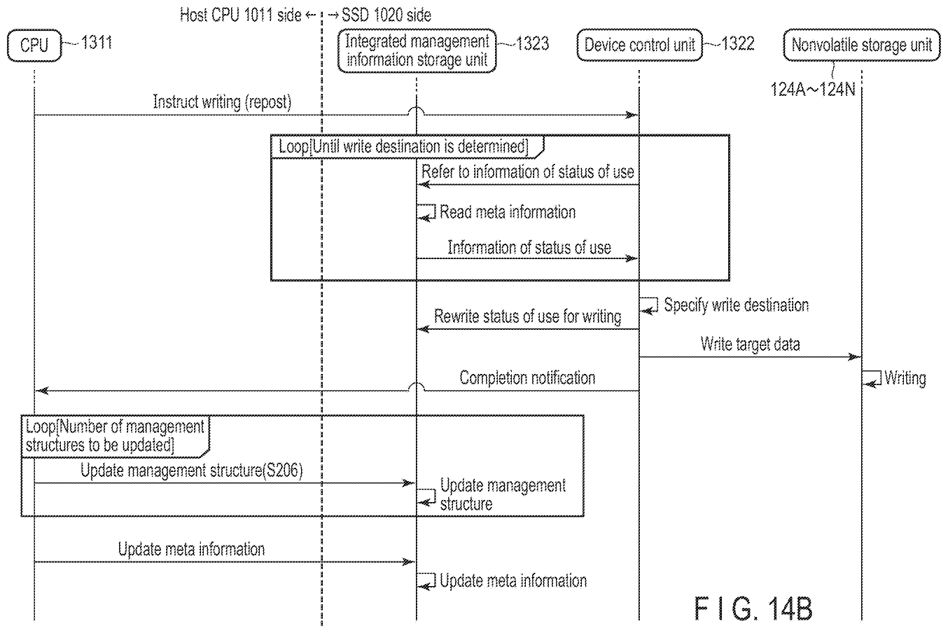

FIGS. 14A and 14B are sequence diagrams of write processing in the present embodiment. The sequence diagram is basically similar to the sequence diagrams of FIGS. 12A and 12B, but differs in that the CPU 1311 refers to the information in the integrated management information storage unit 1323. In addition, there are no processing of synchronizing with the CPU 1311 side after a device control unit 1322 updates the integrated management information storage unit 1323 and no processing of invalidating the integrated management information storage unit 1323 when the CPU 1311 updates the management structure and the meta information. Note that although the CPU 1311 directly refers to the integrated management information storage unit 1323 in this sequence diagram, the device control unit 1322 may intervene in some form. In particular, in a case where there is no necessary information in the integrated management information storage unit 1323, processing of exchanging information between the nonvolatile storage units 1 to N (124A to 124N) through the device control unit 1322 is not illustrated, but needs to be appropriately executed.

### Supplement regarding Memory Device and Capacity of Integrated Management Information Storage Unit

Some supplements will be given for a capacity of the integrated management information storage unit 1323 and a type of memory device. First, the capacity of the integrated management information storage unit 1323 can be grasped by the CPU 1311 by using the function investigation unit 1012 as in the fourth embodiment.

The total capacity of the management structure and the meta information necessary for maintaining the file system may be adjusted by using this. For example, a unit size of the nonvolatile storage management can be larger as the block size is larger, therefore a required capacity of the integrated management information storage unit 1323 can be reduced. In this way, by suppressing the amount of the management structure and the meta information to be equal to or less than the capacity of the integrated management information storage unit 1323 in advance, the exchange processing between the nonvolatile storage units A to N (124A to 124N) becomes unnecessary.

In addition, as a memory device for realizing the integrated management information storage unit 1323, not only an SRAM or a DRAM but also a nonvolatile memory such as an SCM may be used. When it can be realized by using an SCM having a sufficient capacity, since all the management structures and the pieces of meta information can be held in the nonvolatile memory, it is not necessary to perform processing of developing or persisting from the nonvolatile storage units A to N (124A to 124N). Even in a case where an SCM having a small capacity is used, a method of holding only a portion having a high reference frequency in the SCM and exchanging the other portions between the nonvolatile storage units A to N (124A to 124N) may be adopted.

### Summary of Fifth Embodiment

As described above, by using a bus having a function of directly accessing the integrated management information storage unit 1323 inside the SSD 1320 from the CPU 1311, the management information common to both portions can be aggregated in the SSD 1320. As a result, the complexity of management by software is eliminated, and the improvement in processing speed can also be expected. In addition, by configuring the integrated management information storage unit 1323 with a nonvolatile memory such as the SCM, an overhead of restoration and persistence can be reduced.

### Sixth Embodiment (Estimation Unit is Added to First Embodiment)

### Block Diagram and Operation Outline

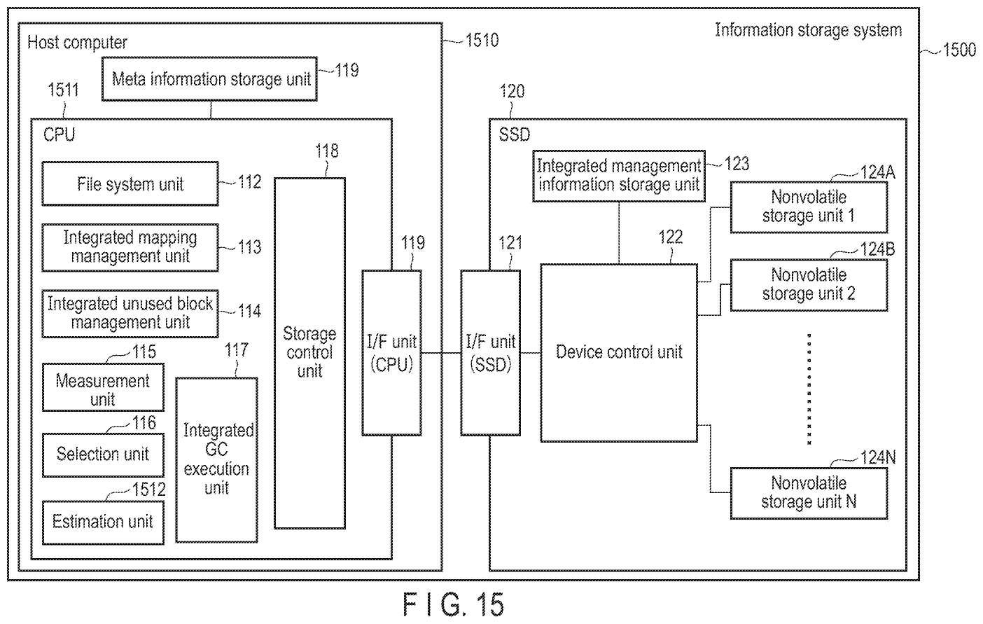

The present embodiment is a modification of the first embodiment. The following description will be made by extending the first embodiment, but can be similarly extended to the second to fifth embodiments. FIG. 15 is a block diagram of the present embodiment. A difference from the first embodiment illustrated in FIG. 1 is that an estimation unit 1512 is added. An information storage system 1500, a host computer 1510, and a CPU 1511 are denoted by new numbers because the estimation unit 1512 is added.

The estimation unit 1512 estimates a characteristic change until a next timing of executing garbage collection based on a measurement result of the measurement unit 115, and provides information necessary for selection of a GC program to the selection unit 116 based on the estimation result. Examples of the estimation include estimation of a predicted measurement value by extending an approximate line interpolated with respect to a measurement value (one measurement value such as a write amount per unit time and the number of writes per unit time, or one value calculated from a plurality of measurement values) for a certain area, and estimation using a model generated by machine learning. As described in the first embodiment, there are two possible timings of executing the garbage collection, that is, when an application requests writing and when the application executes the garbage collection independently. Since it is difficult to grasp the former timing in advance, the latter timing at which the garbage collection is executed independently of the application will be described here with an intention. Note that the timing at which the application writes may be predicted by using machine learning or the like, and a characteristic change until the timing may be estimated.

There are two possible execution timings of the estimation processing by the estimation unit 1512. One is a case where the GC program is executed successively when it is selected. The other is a case where the GC program is executed independently of the selection of the GC program. In the former case, the estimation can be performed for the timing at which writing has occurred or an area in which writing has occurred, but there is a possibility that the time until completion of writing will be long. In the latter case, the GC program can be selected in advance without interfering with the I/O processing, but there is a possibility that the characteristic changes from the estimation to the actual execution of the garbage collection. In the present embodiment, either method may be adopted, and the selection is a design matter. When the SSD is divided into logical areas such as namespaces and partitions, selection of the former and the latter may be changed for each logical area, or one method may be adopted for the entire drive.

### Summary of Sixth Embodiment

As described above, the estimation unit 1512 is further provided, and the estimation unit 1512 estimates a change in future I/O characteristic from a measurement result by the measurement unit 115, and the selection unit 116 selects a GC program based on the estimation, so that a more appropriate GC program can be selected.

### Seventh Embodiment (Input Reception Unit is Added to Sixth Embodiment)

### Block Diagram and Operation Outline

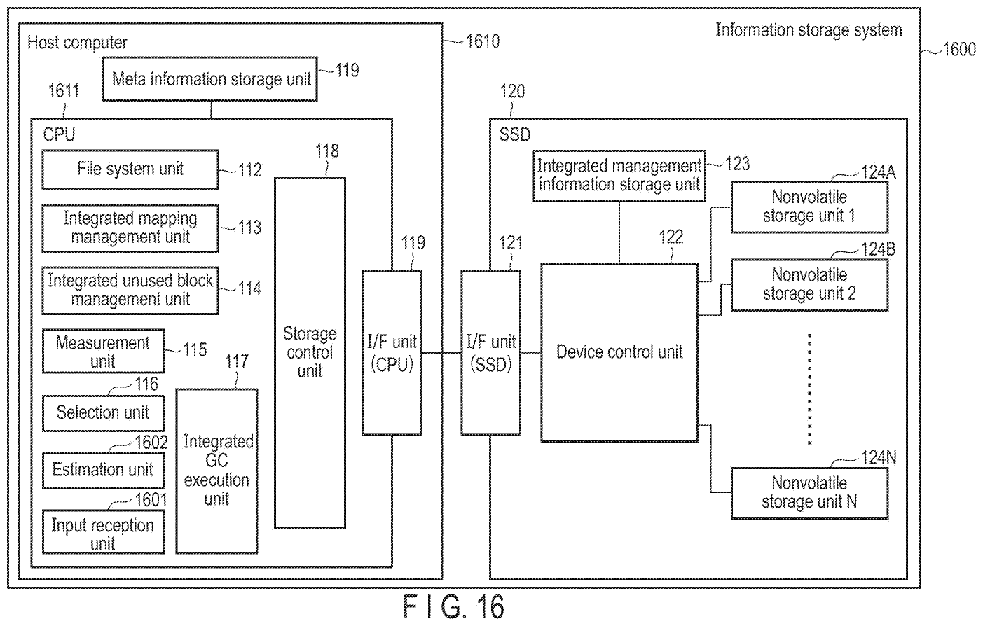

FIG. 16 is a block diagram of the present embodiment. The present embodiment is a modification of the sixth embodiment, and is different in that an input reception unit 1601 is added, and an estimation unit 1602 has a function of receiving information regarding I/O characteristic from the input reception unit 1601.

The input reception unit 1601 has a function of receiving information regarding the characteristic of an I/O executed by an application (not illustrated) using the file system unit 112 from the application, appropriately formatted the information, and notifying the information to the estimation unit 1602. As a result, when the estimation unit 1602 estimates the change in the I/O characteristic, it is possible to perform estimation with higher accuracy than the sixth embodiment that uses only the information of the measurement unit 115. Note that in a case where a plurality of applications having different I/O characteristics use one logical area, the input reception unit 1601 adjusts these characteristics and then notifies the estimation unit 1512 of the adjusted characteristics. For example, in a case where it is found that an application A that has notified the I/O characteristic that the writing occurs more frequently than the reading and an application B that has notified the I/O characteristic that the reading occurs more frequently than the writing use the same logical area, the input reception unit 1601 notifies the estimation unit 1602 of the I/O characteristic that both the reading and the writing occur frequently.

Here, a qualitative expression such as “large” or “small” is used, but an expression such as “writing X times/second” may be quantitatively used. Then, in a case where the I/O characteristic is received in the quantitative expression, the input reception unit 1601 may hold a threshold as to whether or not to integrate a plurality of received characteristics. For example, in a case where the threshold is “writing 10 times/second”, when an I/O characteristic of “writing 11 times/second” is received, the I/O characteristic is integrated with another I/O characteristic (for example, “reading 20 times/second”) and notified, but when an I/O characteristic of “writing five times/second” is received, the I/O characteristic is not integrated.

### Summary of Seventh Embodiment

As described above, the input reception unit 1601 is further provided, the characteristic of the I/O performed on the file system by the application is received, and the content is notified to the estimation unit 1602, so that the estimation unit 1602 can estimate the change in the I/O characteristic with higher accuracy, and the selection unit 116 can efficiently select an appropriate GC program.

While certain embodiments have been described, these embodiments have been presented by way of example only, and are not intended to limit the scope of the inventions. Indeed, the novel devices and methods described herein may be embodied in a variety of other forms; furthermore, various omissions, substitutions and changes in the form of the embodiments described herein may be made without departing from the spirit of the inventions. The accompanying claims and their equivalents are intended to cover such forms or modification as would fall within the scope and spirit of the inventions.

What is claimed is:

1. A storage system comprising:
a host computer; and
a storage device which is a host management type storage device in which a stored location of data to be stored is managed by processing operated in the host computer,
wherein the host computer includes
a processor configured to control an operation of the host computer,
a file system configured to provide a function of storing data as a file on the storage device, and
a storage control unit configured to control the storage device by issuing a command to the storage device and receiving a response from the storage device, and
the file system has a structure for managing a file by using
a management structure and metadata that manage correspondence between stored data and the storage position of the data on the file system, and
bitmap information for identifying a unit area that holds valid data in the file system and a unit area that does not hold valid data,
the management structure and the metadata are managed by an integrated mapping management function executed by the processor,
the bitmap information is managed by an integrated unused block management function executed by the processor,
the storage device includes a device control unit configured to control an operation of the storage device, and
one or more nonvolatile storage units that hold data for a long period of time, and
the device control unit is configured to manage information for identifying unit areas that hold valid data in the storage device and unit areas that do not hold valid data by using the bitmap information used for management of the file system shared with the host computer.

2. The storage system of claim 1, wherein:
the file system is further configured to, when processing a new storage request, refer to at least one of the bitmap information and specify that there is free areas of which total amount size in the file system is sufficient for the request in the file system;
the storage control unit is further configured to
generate a data storage command including the bitmap information corresponding to the area specified by the file system and data that is a target of the storage request, notify the storage device of the data storage command, and cause the storage device to store the target data,
receive information on a stored location of the target data from the storage device as a response to the storage processing executed by the storage device, and
notify the file system of the information of the stored location; and
the file system is further configured to request the integrated mapping management function to update the management structure and metadata based on the notified information on the stored location, and request the integrated unused block management function to update the bitmap information.

3. The storage system of claim 2, wherein:
the processor of the host computer further includes an integrated garbage collection function of specifying invalid data in the file system with reference to the at least one bitmap information, and instructing execution of garbage collection for releasing an area that holds the invalid data;
the file system is further configured to instruct execution of the garbage collection through the integrated garbage collection function when it is determined that there is no free areas of which a total amount size is sufficient for processing the new storage request,
the storage control unit is further configured to
generate a command for requesting valid data to be migrated from a migration source area in which the valid data and invalid data are mixed to another area along with the execution of the garbage collection by the integrated garbage collection function, the command being accompanied by bitmap information indicating valid/invalid information of data held in the migration source area, notify the storage device of the generated command, and integrally execute garbage collection of the file system and garbage collection in the storage device,
receive, from the storage device, information on a new storage location that is a migration destination of the valid data as a response to the garbage collection executed in the storage device, and
notify the file system of the information on the stored location through the integrated garbage collection function, and
the file system is further configured to request the integrated mapping management function to update the management structure and metadata based on the notified information on the stored location, and request the integrated unused block management function to update the bitmap information.

4. The storage system of claim 2, wherein the integrated mapping management function and the integrated unused block management function are further configured to manage
the stored location for at least one type of information of the management structure, metadata, and bitmap information which are frequently updated and served as a starting point of the file system,
by using an entry point determined in advance by the file system, the storage control unit, and the storage device, a management table indicated by the entry point, and a conversion table of a logical address and a physical address.

5. The storage system of claim 4, wherein the storage device further includes
as an area for holding the management table indicated by the entry point, and the conversion table of the logical address and the physical address,
a logical or physical nonvolatile storage unit that satisfies at least one of (a) available number of writings is larger than the nonvolatile storage unit, (b) a latency associated with reading and writing is small, (c) a rate of occurrence of an error associated with reading and writing is low, and (d) it is controlled by the device control unit so as to a correction rate is high when an error occurs associated with reading and writing.

6. The storage system of claim 2, wherein the integrated mapping management function and the integrated unused block management function are further configured to manage the stored location for at least one type of information of the management structure, metadata, and bitmap information which are frequently updated and served as a starting point of a file system, via a key-value store type control interface determined in advance by the file system, the storage control unit, and the storage device.

7. The storage system of claim 2, wherein the integrated mapping management function and the integrated unused block management function are further configured to secure
a storage location for at least one type of information of the management structure, metadata, and bitmap information which are frequently updated and serve as a starting point of the file system in a storage unit that,
has non-volatility,
is able to be read and written in a smaller unit than the nonvolatile storage unit, and
satisfies at least one of (a) available number of writings is larger than the nonvolatile storage unit, (b) a latency associated with reading and writing is small, (c) a rate of occurrence of an error associated with reading and writing is low, and (d) it is controlled by the device control unit so as to a correction rate is high when an error occurs associated with reading and writing.

8. The storage system of claim 3, wherein:
the CPU of the host computer further includes
a monitoring function of monitoring reading from and writing to the storage device via the file system, and
a selection function of selecting an execution algorithm of garbage collection for securing a free area in the file system and the storage device based on a result of monitoring by the monitoring function, and notifying the integrated garbage collection function of the execution algorithm; and
the integrated garbage collection function further configured to specify an area that includes invalid data and is a migration source from the file system according to the selected execution algorithm, and specify a bitmap corresponding to the area.

9. The storage system of claim 8, wherein:
the processor of the host computer further includes an estimation function of estimating a future I/O characteristic of the file system based on the result monitored by the monitoring function and outputting the estimated I/O characteristic to the selection function; and
the selection function is further configured to select the execution algorithm of the garbage collection based on a variation of the future I/O characteristic output by the estimation function.

10. The storage system of claim 9, wherein:
the processor of the host computer further includes an input reception function of receiving information regarding a read/write characteristic executed by an application from the application requesting read/write with respect to the file system, and inputting the information to the estimation function; and
the estimation function is further configured to perform estimation by using the characteristic information input from the input reception function.

11. The storage system of claim 1, wherein:
the host computer and the storage device are coupled by using a bus having cache coherency in addition to a function of reading and writing data as a storage;
the host computer further includes a meta information storage unit that stores the management structure, metadata, and bitmap managed by the integrated mapping management function and the integrated unused block management function;
the storage device further includes an integrated management information storage unit that also functions as a cache of information when the information stored in the meta information storage unit of the host computer is received;
a change made by the device control unit to the integrated management information storage unit is reflected in the meta information storage unit by a cache coherency function by the bus; and
information stored in the integrated management information storage unit is invalidated according to the change of the information stored in the meta information storage unit by the processor.

12. The storage system of claim 1, wherein:
the host computer and the storage device are coupled by using a bus having a function of accessing a memory mounted inside the storage device in addition to a function of reading and writing data as a storage;
the storage device further includes an integrated management information storage unit that reads at least a part of the management structure, metadata, and bitmap managed by the integrated mapping management function and the integrated unused block management function of the host computer from a nonvolatile storage unit, and temporarily holds the management structure, metadata, and bitmap; and
each function of the file system, the integrated mapping management function, and the integrated unused block management function of the host computer is configured to directly access the integrated management information storage unit by using a memory access function of the bus, and use information held by the storage device to manage the file system.

13. A method of managing a storage system including a host computer and a storage device which is a host management type storage device in which a stored location of data to be stored is managed by processing operated by the host computer, the method comprising:
constructing a file system in the host computer, the file system providing a function of storing data as a file on the storage device such that the file system manages the file by using
a management structure and metadata that manage correspondence between stored data and the storage position of the data on the file system, and
bitmap information for identifying a unit area that holds valid data in the file system and other unit areas;
managing the management structure and the metadata by an integrated mapping management function executed by a CPU; and
managing the bitmap information by an integrated unused block management function executed by the CPU, wherein
the storage device manages information for identifying unit areas that hold valid data in the storage device and unit areas that do not hold valid data by using the bitmap information used for management of the file system shared with the host computer.

14. The method of claim 13, further comprising:
constructing the file system such that when processing a new storage request, the file system refers to at least one of the bitmap information and specify that there is free areas of which total amount size in the file system is sufficient for the request in the file system ;
generating a data storage command including the bitmap information corresponding to the area specified by the file system and data that is a target of the storage request, notifying the storage device of the data storage command, and causing the storage device to store the target data;
receiving information on a storage location of the target data from the storage device as a response to the storage processing executed by the storage device;
notifying the file system of the information of the storage location; and
constructing the file system such that the file system requests the integrated mapping management function to update the management structure and metadata based on the notified information on the storage location, and requests the integrated unused block management function to update the bitmap information.

15. The method of claim 14, further comprising:
constructing the file system such that when it is determined that there is no free areas of which a total amount size is sufficient for processing the new storage request, the file system specifies invalid data in the file system with reference to the at least one bitmap information, and instructs execution of garbage collection through an integrated garbage collection function that instructs execution of garbage collection for releasing an area that holds the invalid data;
generating a command for requesting valid data to be migrated from a migration source area in which the valid data and invalid data are mixed to another area along with the execution of the garbage collection by the integrated garbage collection function, the command being accompanied by bitmap information indicating valid/invalid information of data held in the migration source area, notifying the storage device of the generated command, and integrally executing garbage collection of the file system and garbage collection in the storage device;
receiving, from the storage device, information on a new storage location that is a migration destination of the valid data as a response to the garbage collection executed in the storage device;
notifying the file system of the information on the storage location through the integrated garbage collection function; and
constructing the file system such that the file system requests the integrated mapping management function to update the management structure and metadata based on the notified information on the storage location, and requests the integrated unused block management function to update the bitmap information.

16. The method of claim 14, further comprising managing
the storage location for at least one type of information of the management structure, metadata, and bitmap information which are frequently updated and serve as a starting point of the file system,
by using an entry point determined in advance by the file system, the storage control unit, and the storage device, a management table indicated by the entry point, and a conversion table of a logical address and a physical address.

17. The method of claim 16, wherein the storage device includes
as an area for holding the management table indicated by the entry point, and the conversion table of the logical address and the physical address,
a logical or physical nonvolatile storage unit that satisfies at least one of (a) available number of writings is larger than the nonvolatile storage unit, (b) a latency associated with reading and writing is small, (c) a rate of occurrence of an error associated with reading and writing is low, and (d) it is controlled by the device control unit so as to a correction rate is high when an error occurs associated with reading and writing.

18. The method of claim 14, further comprising managing the storage location for at least one type of information of the management structure, metadata, and bitmap information which are frequently updated and serve as a starting point of a file system, via a key-value store type control interface determined in advance by the file system, the storage control unit, and the storage device.

19. The method of claim 14, further comprising securing
the storage location for at least one type of information of the management structure, metadata, and bitmap information which are frequently updated and serve as a starting point of the file system in a storage unit that,
has non-volatility,
is able to be read and written in a smaller unit than the nonvolatile storage unit, and
satisfies at least one of (a) available number of writings is larger than the nonvolatile storage unit, (b) a latency associated with reading and writing is small, (c) a rate of occurrence of an error associated with reading and writing is low, and (d) it is controlled by the device control unit so as to a correction rate is high when an error occurs associated with reading and writing.

20. The method of claim 15, further comprising:
monitoring reading from and writing to the storage device via the file system; and
selecting an execution algorithm of garbage collection for securing a free area in the file system and the storage device based on a result of the monitoring, and notifying the integrated garbage collection function of the execution algorithm, wherein
the integrated garbage collection function further specifies an area that includes invalid data and is a migration target from the file system according to the selected execution algorithm, and specifies a bitmap corresponding to the area.
